(19) United States
(12) Patent Application Publication
(10) Pub. No.: US 2017/0080855 A1
(43) Pub. Date: Mar. 23, 2017

(54) VEHICLE MONITORING SYSTEM AND VEHICLE MONITORING METHOD

(71) Applicant: NANJING ASIATEK TECHNOLOGY LTD., Nanjing (CN)

(72) Inventor: HAI-FENG DENG, Shenzhen (CN)

(21) Appl. No.: 14/928,667

(22) Filed: Oct. 30, 2015

(30) Foreign Application Priority Data
Sep. 18, 2015 (CN) 201510596480.7

(51) Int. Cl. B60Q 9/00; G01S 19/13

(52) U.S. Cl. CPC B60Q 9/00; G01S 19/13; G01P 15/00

(57) ABSTRACT

A vehicle monitoring system includes a positioning module, a gravity acceleration sensor, and a position determining module. The positioning module receives data transmitted from a global positioning system satellite to obtain a position of a vehicle or of a device which is co-positional with the vehicle. The gravity acceleration sensor senses acceleration of the vehicle. When the gravity acceleration of the vehicle is zero, the position determining module determines the last received position data as position of the vehicle. When the gravity acceleration of the vehicle is not zero, the position determining module can be used to form a relationship between current position and a speed limit applicable to the present position of the vehicle and issue warnings as appropriate. A vehicle monitoring method is also provided.

### CROSS-REFERENCE TO RELATED APPLICATIONS

This application claims priority to Chinese Patent Application No. 201510596480.7, filed on Sep. 18, 2015, the contents of which are incorporated by reference herein.

### FIELD

The subject matter herein relates to a monitoring system.

### BACKGROUND

Global positioning systems are generally installed on vehicles to obtain the position of the vehicle. The global positioning systems can be a part of the vehicle entertainment system.

### BRIEF DESCRIPTION OF THE DRAWINGS

Implementations of the present technology will now be described, by way of example only, with reference to the attached figures.

FIG. 1 is a block diagram of a vehicle monitoring system.

FIGS. 2 and 3 are a flowchart of a vehicle monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

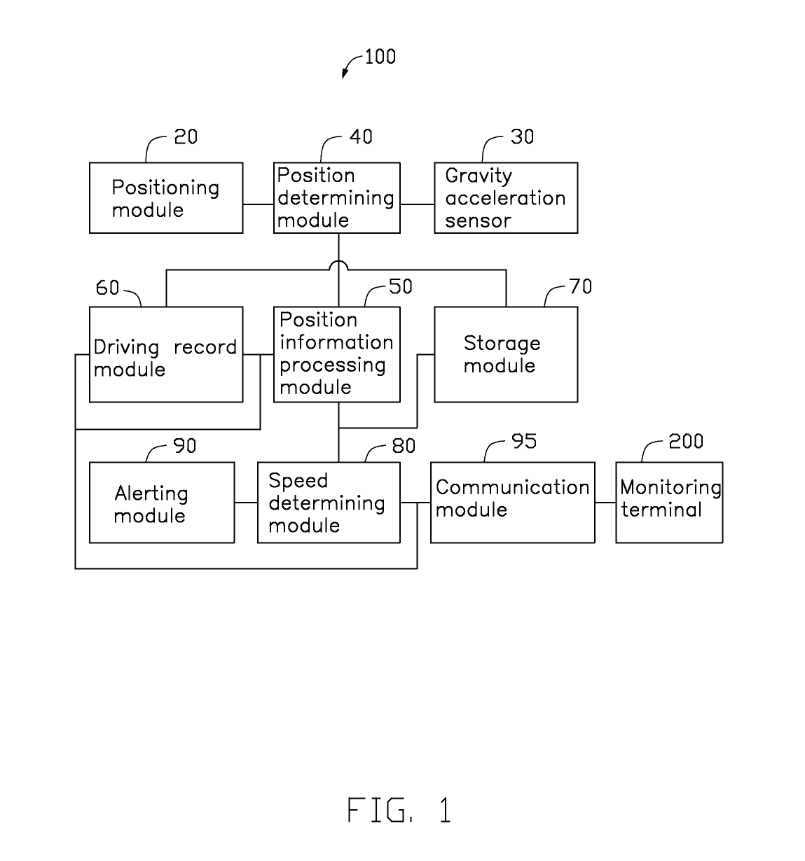

FIG. 1 illustrates a vehicle monitoring system 100. The vehicle monitoring system 100 includes a positioning module 20, a gravity acceleration sensor 30, and a position determining module 40. The positioning module 20 and the gravity acceleration sensor 30 are located on a vehicle. The position determining module 40 may be located on the vehicle or another terminal which is co-positional with the vehicle, for example, a computer.

The positioning module 20 is configured to receive position data transmitted from a global positioning system satellite to obtain a position. The gravity acceleration sensor 30 is configured to sense a gravity acceleration of the vehicle. When the vehicle is stationary, the gravity acceleration of the vehicle is zero. When the vehicle is moving, the gravity acceleration of the vehicle is not zero because of the roughness of the road and/or movement of the vehicle.

When the gravity acceleration of the vehicle is zero, the position determining module 40 determines the last received position of the vehicle to obtain the present position of the vehicle. When the gravity acceleration of the vehicle is not zero, the position determining module 40 determines currently received position data as position of the vehicle thereby establishing the present position of the vehicle.

The vehicle monitoring system 100 further includes a position information processing module 50. The position information processing module 50 determines a speed of the vehicle, a driving direction of the vehicle, and a driving distance of the vehicle.

The vehicle monitoring system 100 further includes a driving record module 60. The driving record module 60 creates a driving record of the vehicle according to the speed of the vehicle, the driving direction of the vehicle, and the driving distance of the vehicle. The driving record of the vehicle includes the position of the vehicle and the time of each position of the vehicle.

The vehicle monitoring system 100 further includes a storage module 70, a speed determining module 80, and an alerting module 90. The storage module 70 stores speed ranges corresponding to positions. The speed determining module 80 determines whether the speed of the vehicle is within the speed range corresponding to the position of the vehicle. When the speed of the vehicle is beyond the speed range corresponding to the position of the vehicle, the alerting module 90 gives a warning. In one embodiment, the alerting module 90 is a speaker and makes a sound when the speed of the vehicle is beyond the speed range corresponding to the position of the vehicle. In another embodiment, the alerting module 90 is a visual warning.

The vehicle monitoring system 100 further includes a communication module 95. The communication module 95 transmits an identifying information of the vehicle, the position of the vehicle, the speed of the vehicle, the driving direction of the vehicle, the driving distance of the vehicle, whether the vehicle is travelling at a speed which is beyond a permitted speed, and the driving record of the vehicle. This information is transmitted to a monitoring terminal 200. The identifying information of the vehicle is unique. The identifying information of the vehicle can be a license plate number of the vehicle.

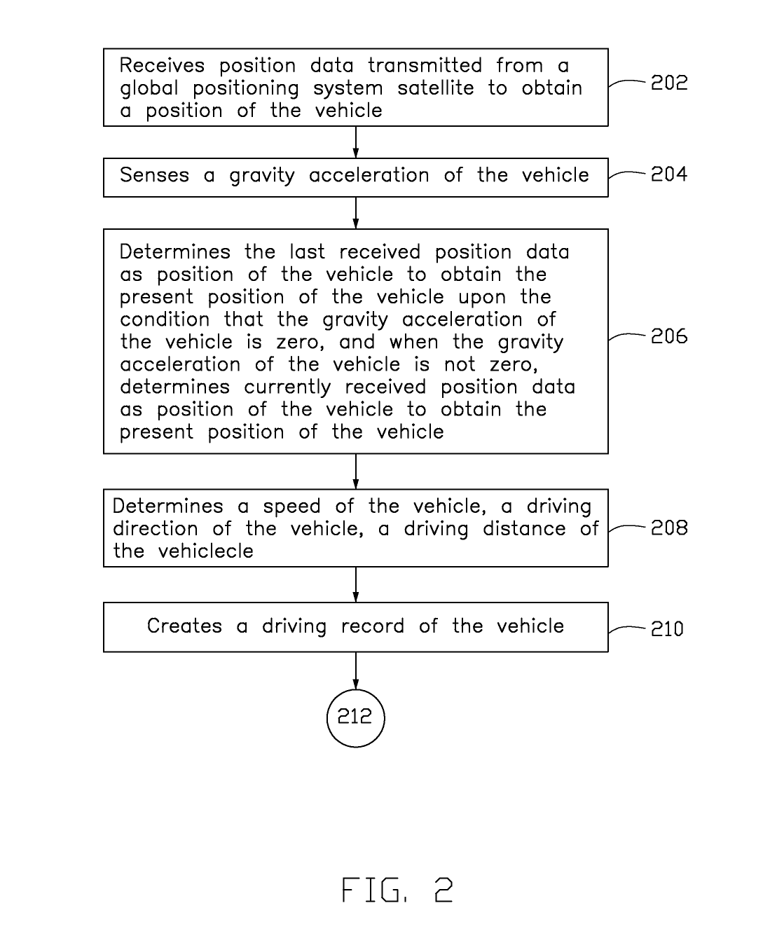

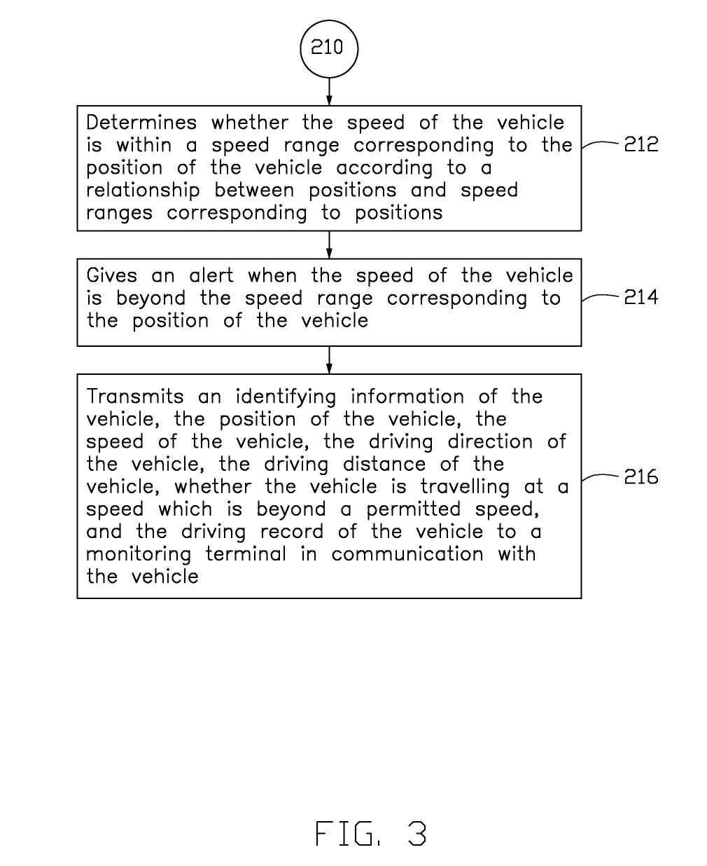

FIGS. 2 and 3 illustrate a flowchart of a method for preventing speeding. The illustrated order of blocks in FIG. 2 is illustrative only and the order of the blocks can change. Additional blocks can be added or fewer blocks may be utilized without departing from this disclosure. The example method can begin at block 202.

At block 202, the positioning module 20 receives position data transmitted from a global positioning system satellite, to obtain a position of the vehicle.

At block 204, the gravity acceleration sensor 30 senses a gravity acceleration of the vehicle.

At block 206, the position determining module 40 determines the last received position data as position of the vehicle to obtain the present position of the vehicle upon the condition that the gravity acceleration of the vehicle is zero, and when the gravity acceleration of the vehicle is not zero, the position determining module 40 determines currently received position data as position of the vehicle to obtain the present position of the vehicle.

At block 208, the position information processing module 50 determines a speed of the vehicle, a driving direction of the vehicle, and a driving distance of the vehicle.

At block 210, the driving record module 60 creates a driving record of the vehicle, such driving record comprising the speed of the vehicle, the driving direction of the vehicle, and the driving distance of the vehicle. The driving record of the vehicle includes the positions of the vehicle and the times of the positions of the vehicle.

At block 212, the speed determining module 80 determines whether the speed of the vehicle is within a speed range applicable to the position of the vehicle, according to a relationship between vehicle positions and speed ranges corresponding to those vehicle positions.

At block 214, the alerting module 90 gives an alert when the speed of the vehicle is beyond the speed range corresponding to the position of the vehicle.

At block 216, the communication module 95 transmits an identifying information of the vehicle, the position of the vehicle, the speed of the vehicle, the driving direction of the vehicle, the driving distance of the vehicle, whether the vehicle is travelling at a speed which is beyond a permitted speed, and the driving record of the vehicle to a monitoring terminal 200 in communication with the vehicle. The identifying information of the vehicle is unique. The identifying information of the vehicle can be a license plate number of the vehicle.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A vehicle monitoring system comprising:
a positioning module configured to receive data transmitted from a global positioning system satellite to obtain a position;
an acceleration sensor configured to sense acceleration of the vehicle; and
a position determining module configured to, when the gravity acceleration of the vehicle is zero, determine the last received position of the vehicle to obtain the present position of the vehicle and when the gravity acceleration of the vehicle is not zero, determine currently received position data as position of the vehicle to obtain the present position of the vehicle.

2. The vehicle monitoring system as claimed in claim 1, further comprising:
a communication module configured to transmit an identifying information of the vehicle and the position of the vehicle to a monitoring terminal communicated with the vehicle.

3. The vehicle monitoring system as claimed in claim 2, wherein the identifying information of the vehicle is a license plate number of the vehicle.

4. The vehicle monitoring system as claimed in claim 1, further comprising:
a driving record module configured to create a driving record of the vehicle, the driving record of the vehicle comprises the positions of the vehicle and the times of the positions of the vehicle.

5. The vehicle monitoring system as claimed in claim 1, further comprising:
a position information processing module configure to determine a speed of the vehicle.

6. The vehicle monitoring system as claimed in claim 5, further comprising:
a storage module configured to store speed ranges corresponding positions;
a speed determining module configured to determine whether the speed of the vehicle is within the speed range corresponding to the position of the vehicle.

7. The vehicle monitoring system as claimed in claim 6, further comprising:
a alerting module configured to gives a warning when the speed of the vehicle is beyond the speed range corresponding to the position of the vehicle.

8. The vehicle monitoring system as claimed in claim 7, wherein the alerting module is a speaker and makes a sound when the speed of the vehicle is beyond the speed range corresponding to the position of the vehicle.

9. The vehicle monitoring system as claimed in claim 7, wherein the alerting module is a visual warning.

10. A vehicle monitoring method comprising:
receiving data transmitted from a global positioning system satellite to obtain a position of a vehicle;
sensing acceleration of the vehicle; and
determining the last received position of the vehicle to obtain the present position of the vehicle upon the condition that the acceleration of the vehicle is zero, and when the acceleration of the vehicle is not zero, determining currently received position data as position of the vehicle to obtain the present position of the vehicle.

11. The vehicle monitoring method as claimed in claim 10, further comprising:
creating a driving record of the vehicle, the driving record of the vehicle comprising the position of the vehicle and the times of the positions of the vehicle.

12. The vehicle monitoring method as claimed in claim 11, further comprising:
transmitting the driving record of the vehicle and an identifying information of the vehicle to a monitoring terminal communicated with the vehicle.

13. The vehicle monitoring method as claimed in claim 12, wherein the identifying information of the vehicle is a license plate number of the vehicle.

14. The vehicle monitoring method as claimed in claim 10, further comprising:
determining a speed of the vehicle according to the position of the vehicle.

15. The vehicle monitoring method as claimed in claim 14, further comprising:
determining whether the speed of the vehicle is within a speed range applicable to the position of the vehicle according to a relationship between vehicle positions and speed ranges corresponding to positions.

16. The vehicle monitoring method as claimed in claim 15, further comprising:
giving an alert when the speed of the vehicle is beyond the speed range corresponding to the position of the vehicle.
